(19) United States
(12) Patent Application Publication
(10) Pub. No.: US 2020/0024950 A1
(43) Pub. Date: Jan. 23, 2020

(54) ROTOR BLADE ASSEMBLY COMPRISING A LOCKING ELEMENT FOR AXIALLY SECURING A REINFORCEMENT ELEMENT OF A REINFORCEMENT STRUCTURE PROVIDED RADIALLY INWARDLY

(71) Applicant: Rolls-Royce Deutschland Ltd & Co KG, Blankenfelde-Mahlow (DE)

(72) Inventors: Sven BRUEGGMANN, Bestensee (DE); Miklos GAEBLER, Potsdam (DE)

(21) Appl. No.: 16/376,389

(22) Filed: Apr. 5, 2019

(30) Foreign Application Priority Data
Apr. 11, 2018 (DE) 10 2018 205 480.0

(51) Int. Cl. F01D 5/02; F01D 5/32

(52) U.S. Cl. CPC F01D 5/02; F05D 2260/30; F05D 2300/6032; F01D 5/32

(57) ABSTRACT

A rotor blade assembly group for an engine includes a blade carrier with rotor blades along a circle line about a central axis of the group, wherein the blade carrier has a carrier section extending radially inwards toward a central axis, the carrier section includes a connecting area at which a stiffening structure with a stiffening element is fixedly attached, and the stiffening element is arranged at a face side of the blade carrier. The stiffening element is axially secured at the face side of the blade carrier via a barrier element, that (a) is affixed radially further inside at or to a flange section of the blade carrier, or (b) is formed in front of the blade carrier and engages around the stiffening element with at least one barrier element section.

The invention relates to a rotor blade assembly group for an engine with a blade carrier with multiple rotor blades.

Such a rotor blade assembly group is for example part of a compressor or a turbine of the engine, in particular of a gas turbine engine. Here, the rotor blades are provided along a circle line about a central axis of the, rotor blade assembly group, wherein this central axis usually coincides with the rotational or central axis of the engine. The blade carrier at which the rotor blade is integrally formed or at which separately manufactured rotor blades are affixed via respectively one blade root, has a carrier section that extends radially inwards with respect to the rotor blades in the direction of the central axis. This carrier section usually forms a part of a disc body which—taking into account the available installation space—is formed with a comparatively large area to withstand loads that occur during operation of the engine and that are created through the fast rotation of the rotor blade assembly group about the central axis. The higher the rotational speed of the blade carrier with the rotor blades and thus the load of the blade carrier, the larger the carrier section and consequently the weight of the blade carrier.

What is suggested in DE 101 63 951 C1 and DE 102 18 459 B3 for reducing the weight of a rotor blade assembly group and a rotor comprising the same is to provide a stiffening structure with first and second stiffening elements made of a metal matrix composite (MMC) at blade carrier, which here is ring-shaped or disc-shaped, at a connecting area of the carrier section. Here, respectively one stiffening element is embodied as a fiber-reinforced MMC ring and is arranged at respectively one face side of the blade carrier. Thus, for example two MMC rings are fixedly attached at a connecting area of a radially inwardly extending carrier section of a blade carrier in a mirror-inverted manner, and namely at a first frontal face side and at a second rear face side of the blade carrier. Through the additional stiffening elements in the form of MMC rings, higher rotational speeds can be applied to the blade carrier while it at the same time has a smaller radial extension of the carrier section, and thus can withstand higher loads. At that, thanks to the MMC rings, the weight of the blade carrier is considerably lower than in a blade carrier with the same loadability and a larger carrier section.

In the rotor blade assembly group proposed in DE 101 63 951 C1 and DE 102 18 459 B3, the stiffening elements in the form of MMC rings are fixated independently of each other in a form-fit manner onto respectively one face side of the carrier section and where necessary additionally shrunk onto an axially extending projection of the connecting area. Here, each MMC ring is separately axially secured at the respective face side of the carrier section and arranged above the associated axially extending projection at the connecting area of the carrier section with respect to a radially outwards pointing transversal direction. The fixation and in particular the axial securing oft he individual stiffening elements in the form of MMC rings is effected via a support nose at the MMC ring that is provided with a groove and two support noses at the carrier section that are provided with grooves in combination with a securing pin that is inserted into the grooves of the support noses inserted, and is comparatively elaborate. In addition, the fixation of the MMC rings known from DE 101 63 951 C1 and DE 102 18 459 B3 may not be usable in the highly-loaded area of a high-pressure turbine.

The proposed solution is thus based on the objective to provide a rotor blade assembly group that is improved in this respect and by means of which the previously mentioned disadvantages are avoided or at least reduced.

This objective is achieved with a rotor blade assembly group of claim 1.

Such a rotor blade assembly group comprises at least one stiffening element of a stiffening structure arranged at a face side of a blade carrier, being axially secured via at least one barrier element at the face side of the blade carrier, wherein the at least one barrier element
(a) is radially fixated further inside at or with a flange section of the blade carrier, or
(b) is formed in front of the blade carrier and engages around the stiffening element with at least one barrier element section.

Thus, in the proposed solution, the barrier element that serves for axial securing of the at least one stiffening element, is fixated by means of a flange section of the blade carrier or the stiffening element is formed to be engaged around by the blade carrier itself. Both variants allow for efficient and compact securing of the stiffening element at which blade carrier of a rotor blade assembly group.

Here, a fixation at the flange section is in particular present when the barrier element is formed at a flange section of the blade carrier or is fixedly attached in an immobile manner at the flange section of the [blade carrier] as a separate component. If the barrier element is fixated to the flange section of the blade carrier, it is in particular assumed that the barrier element is provided at a structural component that is not the blade carrier or is formed by the same, and that this structural component is connected to the blade carrier via the flange section of the blade carrier.

The flange section of the blade carrier, which is located radially further inside with respect to the connecting area of the carrier section that is provided for the stiffening structure, facilitates, on the one hand, the connection of the blade carrier to other components of the engine, in particular an axially adjoining rotor blade assembly group. On the other hand, the stiffening element can be easily mounted at the radially further outwardly located carrier section via the radially further inwardly located flange section. In one variant with a barrier element that is fixated at or to the flange section of the blade carrier, the barrier element can for example be formed with a radially outwardly extending base. After the at least one stiffening element has been arranged at the connecting area of the carrier section, the stiffening element can be axially secured via the barrier element axial, as the barrier element projects sufficiently far outwards from the radially further inwardly located flange section with its radially outwardly extending base to make the barrier element abut with a barrier element section at the stiffening element.

At the base, an axially extending barrier element section for the axial securing of the at least one stiffening element can be provided, for example. In particular, the axially extending barrier element section can be formed at the base of the barrier element. An axially extending barrier element section can for example be formed as a ring-shaped or ring-segment-shaped web at a disc-shaped base.

In one embodiment variant, the blade carrier is connected via the flange section to one further blade carrier. This further blade carrier can be part of a rotor blade row that is arranged at an axial distance along the central axis. Thus, the rotor blade assembly group can be part of a group with multiple rows of rotor blade assembly groups that are arranged at an axial distance to each other, in which blade carriers of different rotor blade rows are connected to each other via flange sections in a torque-proof manner. The at least one barrier element is fixated at or to at least one of these flange sections for axial securing of the at least one stiffening element.

In a possible further development, a further stiffening structure with at least one further stiffening element is fixedly attached at one carrier section of the further blade carrier, so that two stiffening elements of the interconnected blade carrier are arranged opposite each other. Here, the at least one barrier element can be arranged between the two stiffening elements. In that case, axially opposing stiffening elements can be secured together via this at least one barrier element. In connecting the two blade carriers via the flange section, in one embodiment variant the one blade carrier with its carrier section that comprises a (first) stiffening element can be axially displaced in the direction of the other blade carrier, so that its first stiffening element is thus pressed in the axial direction against the barrier element that is located between the two stiffening elements, and the barrier element is in turn pressed in the axial direction against the other (second) stiffening element of the other blade carrier. Thus, the barrier element is received in a sandwich-like manner and clamped in between two stiffening elements located opposite each other, whereby at the same time both stiffening elements that are located opposite each other are axially secured against being removed from the respective connecting area. In particular such a embodiment variant with a barrier element arranged between two stiffening elements of different blade carriers can further serve for compensating for the axial play.

In particular in one of the previously described embodiment variants, the barrier element can have two barrier element sections of which a first barrier element section extends axially in the direction of the one (first) stiffening element, and a second barrier element section extends axially in the direction of the other (second) stiffening element opposite to the same. In such a further development, the barrier element can in particular be formed with a T-shaped cross section.

Independently of an axial securing of opposite stiffening elements of stiffening structures of blade carriers that are connected to each other, a barrier element fixated at or to a flange section of a blade carrier can be pressed against the at least one stiffening element also as a part of a connection of the blade carrier to any other engine component to secure it in its axial position at the associated carrier section without a separate fixation of the barrier element itself being required. Thus, with a fixation of a rotor blade assembly group inside the engine, an axial securing of the stiffening element can thus in principle be provided without a separate fixing process.

In a previously described second alternative, in which an axial securing of the at least one stiffening element is realized via at least one barrier element, which is formed by the blade carrier and that engages around the stiffening element with at least one barrier element section, the barrier element section can for example extend radially inwards. In this variant, an engagement around the barrier element is thus provided at a radially outwardly located area of the at least one stiffening element.

In one embodiment variant, the barrier element formed by the blade carrier is provided with at least two barrier element sections that succeed one another along a circumferential direction about the central axis and between which a radially and axially extending gap is present. At that, the barrier element sections of the barrier element that are spatially separated via a gap may for example serve for an axial securing of the at least one stiffening element at two different locations.

For example, it can be provided that at least one radially protruding securing section is provided at the stiffening element, around which the at least two barrier element sections engages in the assembled state of the rotor blade assembly group according to the intended use. For mounting the rotor blade assembly group, the at least one radially protruding securing section of the stiffening element can be inserted into the gap between the two barrier element sections. In other words, the radially protruding securing section is dimensioned such that the securing section can be inserted into the gap provided between the barrier element sections in the axial direction. The securing section is thus narrower, i.e. has a smaller extension in the circumferential direction, than the gap.

If the stiffening element has ben arranged according to the intended use at the blade carrier that is formed with the barrier element, so that the radially protruding securing section is present in der gap between the two barrier element sections, it is provided for one embodiment variant that the stiffening element can be rotated along a circumferential direction about the central axis relative to the carrier section, to insert the radially protruding securing section of the stiffening element at least partially in a gap that is bordered by a barrier element section at the blade carrier, and to lock the barrier element and the stiffening element with each other in the kind of a bayonet joint. Thus, by rotating the stiffening element relative to the blade carrier, the radially protruding securing section of the stiffening element that is at first inserted in the gap between two barrier element sections is transferred into a barrier position in which the stiffening element engages behind the barrier element section with its securing section, or the barrier element section engages around the stiffening element that is present in the barrier position at the radially protruding securing section.

With a comparatively simple mounting of the stiffening element, the previously described mounting process allows for a lasting robust axial securing of the stiffening element at the blade carrier, since the stiffening element is supported in a form-fit manner at the blade carrier, and can only be transferred back into a (mounting) position in which the stiffening element can be separated from the blade carrier by twisting along a circumferential direction about the central axis with respect to the blade carrier.

In one variant, multiple gaps can be present at the barrier element, wherein a gap is respectively provided between two barrier element sections of the blade carrier that succeed one another along a circumferential direction. Thus, different positions along the circumference of the blade carrier can be pre-determined through the multiple gaps, at which a radially protruding securing section of the stiffening element can be inserted according to the intended use. In this manner, at least one relative position is predetermined for the stiffening element, in which the blade carrier can be arranged. Alternatively or additionally, the multiple gaps can be provided for a meshing engagement of multiple respectively radially protruding securing sections that are present at a stiffening element to provide a form-fit connection between the stiffening element and the barrier element across the circumference of the blade carrier at multiple locations for axially securing the stiffening element. Of course, multiple securing sections that are arranged at a distance in the circumferential direction can also be provided at the stiffening element without multiple gaps being present at the blade carrier. In this manner, the stiffening element can for example be affixed at a barrier element section of the blade carrier via different securing sections, and thus in different relative positions to the blade carrier.

In one embodiment variant, at least one separately mountable locking element is provided for securing the stiffening element against any twisting relative to the blade carrier. The separately mountable locking element thus secures the stiffening element, for example against any twisting of the stiffening element with respect to the central axis in the circumferential direction relative to the blade carrier. This is in particular advantageous if, during mounting of the rotor blade assembly group, the stiffening element is brought into form-fit engagement with the barrier element of the blade carrier only through twisting along the circumferential direction, as previously explained.

The at least one locking element may for example be formed in a pin-shaped manner. Alternatively or additionally, the locking element can be mounted axially to the blade carrier.

In a further development, a securing element, via which the at least one locking element can be fixated at the blade carrier, is provided in addition to the at least one locking element. Thus, the securing element may for example also be separately mountable—following mounting of the locking element at the blade carrier—for axially securing the locking element. Thus, the locking element can be axially removed again from the blade carrier only after the securing element has been removed, which then in turn allows for a twisting of the stiffening element at the blade carrier.

For example, the securing element is formed with a securing bracket that is inserted into a receptacle at a head of a pin-shaped locking element. In one embodiment variant, such a securing bracket engages behind a section of the blade carrier, e.g. a barrier element section of the blade-carrier-side barrier element, with a bracket end, for example a spring-elastically deformable bracket end to fixate the securing element at the blade carrier and to secure the locking element against being removed from the blade carrier.

The at least one locking element can for example be inserted into precisely that gap between two barrier element sections through which the radially protruding securing section of the stiffening element can be inserted during mounting of the rotor blade assembly group. With the inserted locking element, any twisting back of the radially protruding securing section of the stiffening element in the gap and thus bringing the blade-carrier-side barrier element section and stiffening-element-side securing section out of mesh is thus blocked.

In a further development, a recess is provided between two securing sections provided at the stiffening element, being at least partially located in the gap between the two barrier element sections in the assembled state of the rotor blade assembly group according to the intended use, so that the locking element that is inserted into the gap according to the intended use also meshes with the recess of the stiffening element. The locking element can thus also be inserted into the recess of the stiffening element and thus enter into a form-fit connection with the stiffening element as well as with the barrier element of the blade carrier to block twisting of the stiffening element relative to the barrier element.

In one embodiment variant, the recess of the stiffening element has a smaller extension in the circumferential direction than the gap of the barrier element. Consequently, the locking element can mesh into the recess of the stiffening element with a shaft-section that is narrower as compared to the head of the locking element, while the wider head of the locking element is partially or completely received in the gap of the blade-carrier-side barrier element.

Independently of the design of the barrier element for axial securing of the at least one stiffening element, at least one cooling hole for cooling air that is to be guided to the stiffening structure can be provided at the carrier section. Here, the at least one cooling hole can for example be provided at a flange area of the carrier section that is located radially further inwardly with respect to the connecting area for the stiffening structure to guide radially outwardly flowing cooling air to the stiffening structure. Here, the provision of at least one cooling hole is e.g. expedient for a rotor blade assembly group for the area of a high-pressure turbine. Due to the cooling effect that can be achieved by the cooling air, where necessary it way be possible to use a less heat-resistant material for the stiffening element of the stiffening structure.

In a further development, optionally multiple cooling holes that are distributed along the circumferential direction or a row of cooling holes can be provided at the carrier section, via which cooling air is guided in the direction of the face side of the blade carrier comprising the stiffening element.

In one variant, it can be provided alternatively or additionally that two cooling holes that are axially offset with respect to one another are formed at the carrier section. Here, cooling air can be guided to a frontal face side via a first cooling hole, and cooling air can be guided to a rear face side of the blade carrier via a second cooling hole to be able to cool at least one stiffening element of the stiffening structure at each face side. In a possible further development, rows of first and second cooling holes that are arranged behind each other along the circumferential direction can be formed at the carrier section in a manner axially offset with respect to one another.

In one embodiment variant, it is provided that at least one stiffening element is formed in a ring-shaped manner. Compared to multiple, for example ring-segment-shaped, stiffening elements, the ring-shaped design of a stiffening element has the advantage of a simpler and faster mounting.

For weight reduction, in one embodiment variant, the at least one stiffening element is at least partially made of a metal matrix composite (MMC, for short). Here, the stiffening element can have an externally coated core of a metal matrix composite. The core can for example be made of a reinforced titanium in MMC design, i.e., in particular of a titanium matrix with ceramic reinforcement.

In one embodiment variant, the connecting area forms at least one axial projection around which the at least one stiffening element engages in a form-fit manner, so that the axial projection is at least partially received between a radially outer and a radially inner section of the stiffening element. Thus, an axially protruding section of the connecting area extends between a radially outer and a radially inner section of the stiffening element. Here, the axial projection can be formed so as to be locally protruding at the connecting area in the kind of a web, and cam for example be received between the two sections of the stiffening element inside a groove-shaped recess of the stiffening element. The form-fit meshing of an axial projection of the connecting area by the stiffening element does not only allow for an improved application of force into and support by the stiffening element, but also an improved linking of the stiffening element at the connecting area of the blade carrier. In this way, the stiffening element can for example be simply axially pushed or plugged on at the face side of the blade carrier and onto the at least one axial projection, and is directly radially secured at the blade carrier through the form-fit engagement of the axial projection.

An axial projection of the connecting area can in principle extend substantially parallel to the central axis and thus substantially perpendicular to a radially extending face side of the carrier section. However, the axial projection can also take on an angle to the face side that is different from 90°.

Further, a transitional area between a substantially radially extending font-end carrier surface at the connecting area and an end of the projection integrally formed thereat can be concavely curved. Here, the degree of curvature and thus the course of a line at this transitional area can be chosen differently depending on the engine and/or the position of the rotor blade assembly group, depending on how strong the forces are that act at the connecting area and with what force components they extend, for example radially and tangentially. For example, a line at the transitional areas extends at an angle of 0° to 45° with respect to the radial direction. Here, the degree of curvature and thus the enclosed angle can also be realized depending on the used manufacturing material for the stiffening element, for example. In particular in view of the metal matrix composite and the fibers provided therein, which can be subjected to higher loads in the circumferential direction about the central axis than in a tangential direction, a smaller angle and thus a more strongly concave curvature may be suitable for the transitional area (ant thus a less “smooth” transition between the end face and projection).

The at least one axial projection can be part of a profile of the connecting area that has a T-shaped, I-shaped or fir-tree-shaped cross section. In a T-shaped profile, two projections axially extending in opposite directions are integrally formed at the connecting area. In an I-shaped profile, i.e., a profile that is formed in the kind of the cross-sectional profile of a double T-bar, correspondingly two pairs of such two projections that axially extend in opposite directions are provided at a radial distance to each other. In a fir-tree-shaped profile, at least two or three pairs of two projections that axially extend in opposite directions are provided, arranged radially above and at a distance to each other, with their axial extension incrementally increasing or decreasing along a radial direction.

In one embodiment variant, a T-shaped, I-shaped or fir-tree-shaped profile of the connecting area extends in the circumferential direction about the central axis. In a further development, the connecting area of a blade carrier is provided with a T-shaped, I-shaped or fir-tree-shaped profile extending over the entire length of the blade carrier in the circumferential direction.

In particular in a fir-tree-shaped cross-sectional profile of the connecting area, a for example ring-shaped stiffening element can be arranged at each face side of the blade carrier, provided with a respectively corresponding cross-sectional profile as a counter-piece and engaging around multiple axial projections defined by the fir-tree-shaped cross-sectional profile of the connecting area in a form-fit manner. Via such a connection between a respective stiffening element and the connecting area of the blade carrier, the radial loads occurring during operation of the engine can be introduced more efficiently from the blade carrier into the stiffening structure. Here, the occurring forces are additionally introduced into the stiffening structure at different radial locations and thus in a distributed manner, so that the force transmission between the blade carrier and the stiffening structure is improved. Also the linking and secure fixation of the stiffening structure at the blade carrier is considerably simplified.

With the proposed rotor blade assembly group, in particular a gas turbine engine can be provided in which the weight of one or multiple rotor blade rows of a compressor and/or of one or multiple rotor blade rows of a turbine, in particular of a high-pressure turbine, is considerably reduced as compared to the rotor blade rows as they are customary in practice, while mounting the stiffening structure and its axial securing is still comparatively simple. Here, one rotor blade assembly group that respectively forms a rotor blade row respectively having multiple ring-shaped or disc-segment-shaped blade carriers and a stiffening structure affixed thereat, can be arranged axially behind each other and can be fixated at each other in a torque-proof manner. But of course it is also possible to combine a proposed rotor blade assembly group for producing a rotor blade row with a further rotor blade assembly group of a further rotor blade row that is not equipped in the proposed manner.

A further aspect of the proposed solution relates to a method for mounting a stiffening element at a rotor blade assembly group provided for an engine.

Here, the rotor blade assembly group comprises at least one blade carrier that has at least one rotor blade that is provided with multiple rotor blades along a circle line about a central axis of the rotor blade assembly group. The blade carrier has a carrier section that extends radially inwards in the direction of the central axis with respect to the at least one rotor blade and at which a stiffening structure with the stiffening element to be mounted is fixedly attached at a face side of the blade carrier. As a part of the proposed mounting method, the stiffening element is axially secured at the face side of the blade carrier via at least one barrier element, which
(a) is fixated radially further inside at or to a flange section of the blade carrier, or
(b) is formed by the blade carrier and engages around the stiffening element with at least one barrier element section.

Here, one embodiment variant of a proposed mounting method can in particular be realize with an embodiment variant of a proposed rotor blade assembly group.

Accordingly, the advantages and features of embodiment variants of a proposed rotor blade assembly group as explained above and in the following also apply to the embodiment variants of a proposed mounting method, and vice versa.

For example, the blade, carrier is connected in a torque-proof manner to a further engine component, in particular one further blade carrier of a further rotor blade assembly group, via the flange section, wherein here the barrier element is pressed axially against the stiffening element. Hence, the barrier element according to the intended use is attached by connecting the blade carrier to a further engine component, and the stiffening element is axially secured through the barrier element.

In another embodiment variant, the stiffening element is first arranged in a mounting position at the carrier section and subsequently rotated into in a barrier position relative to the carrier section along a circumferential direction about the central axis. In this barrier position, at least one securing section that is radially protruding at the stiffening element is received inside a gap that is bordered by the at least one barrier element section. In this way, the barrier element section engages around the stiffening element at the securing section in the barrier position. According to the previously described embodiment variants for a rotor blade assembly group designed for this purpose, the stiffening element is correspondingly rotated into a barrier position, in which a form-fit connection to the barrier element of the carrier section by engagement around the barrier element section and thus an axial securing of the stiffening elements is realized, only after the arrangement at the connecting area of the carrier section has occurred.

In addition, if a stiffening element is in the barrier position, a locking element can be mounted at the blade carrier, via which the stiffening element is secured against twisting relative to the carrier section, in particular against twisting back into the mounting position in which the stiffening element can be axially removed from the blade carrier. The locking element thus blocks the stiffening element that is in its barrier position according to the intended use against being rotated further or rotated back, and thus blocks the stiffening element, so that the form fit between the blade-carrier-side barrier element and the stiffening element attached thereto cannot be released without removing the locking element.

In one embodiment variant, at least one gap between two radially (e.g. inwards) extending barrier element sections of the blade carrier is provided into which a radially protruding securing section of the stiffening element can be inserted to arrange the stiffening element at the carrier section in the mounting position. By subsequently twisting the stiffening element in the circumferential direction, a form fit is achieved between the stiffening element and the blade-carrier-side barrier element in the kind of a bayonet joint. Subsequently, the locking element is inserted into the gap between two barrier element sections of the blade carrier, which has then become free again. In one embodiment variant, this locking element, which may for example be axially inserted at the blade carrier and which blocks rotation of the stiffening element relative to the carrier section, can in turn be secured against being removed from the blade carrier via a securing element that additionally engages at the locking element.

Here, it should be pointed out that the above-described securing of a first element, which may for example be ring-shaped or disc-shaped, such as the stiffening element, at the carrier element, such as the blade carrier, by means of rotating from the mounting position into a barrier position, in which at least one securing section radially protruding at the first element is twisted into a gap that is bordered by a barrier element section of the carrier element in such a manner that the carrier element engages around the first element that is present in the barrier position via the barrier element section, or the first element engages behind the barrier element section via the securing section is advantageous independently of the described solutions for axial securing of engine components, as referring to the rotor blade assembly group. Incidentally, this also applies to the securing of the barrier position by means of an inserted locking element as well as, where applicable, to a securing element that is additionally plugged onto the locking element and by means of which the inserted locking element is secured at the carrier element secured, such as they may be provided in a possible further development.

The accompanying Figures illustrate possible embodiment variants of the proposed solution by way of example.

Herein:

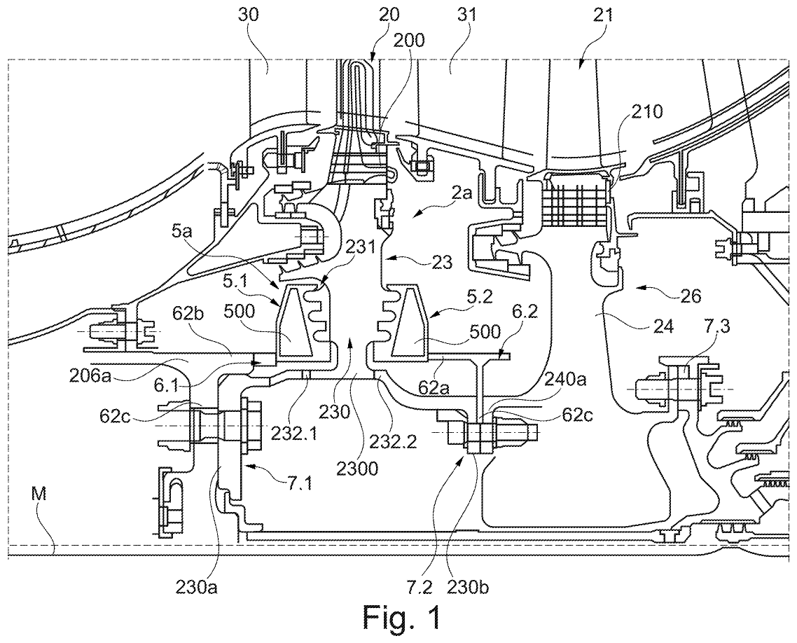

FIG. 1 shows, in a sectioned side view and in sections, a first embodiment variant of a proposed rotor blade assembly group that is installed in a high-pressure turbine of an engine;

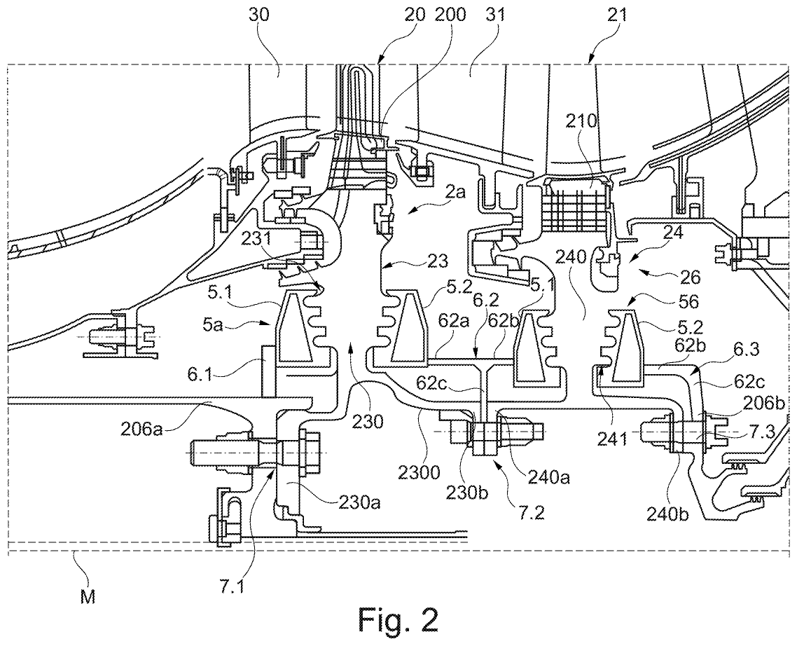

FIG. 2 shows a second embodiment variant in a view corresponding to FIG. 1;

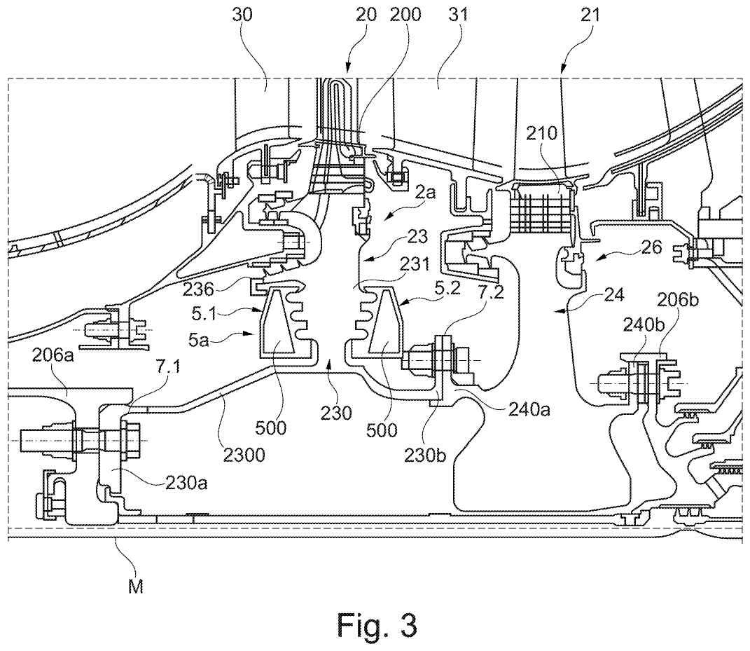

FIG. 3 shows a third embodiment variant in a view corresponding to FIG. 1;

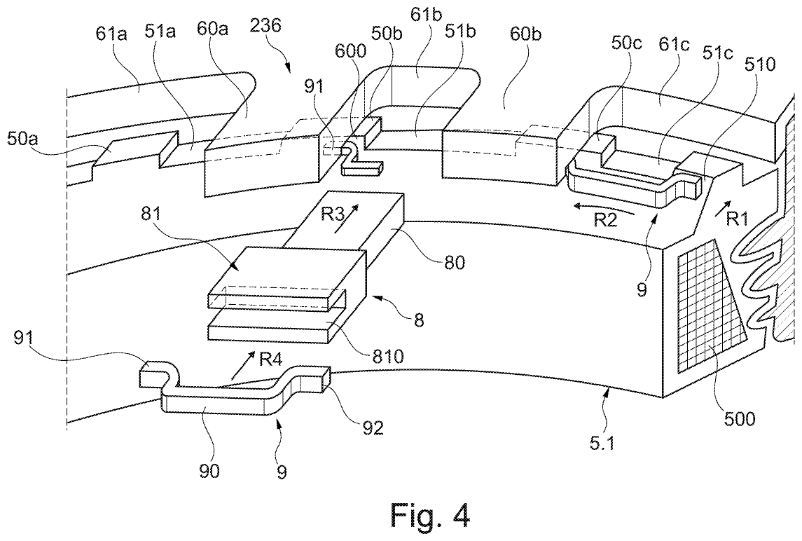

FIG. 4 shows, in a perspective front view and in sections and on an enlarged scale, the axial securing of a stiffening element of the rotor blade assembly group of FIG. 3 via multiple barrier element sections of a blade-carrier-side barrier element engaging around it, with the barrier position of the stiffening element at a blade carrier being secured by means of an inserted pin-shaped locking element and with a securing bracket being fixedly attached thereat;

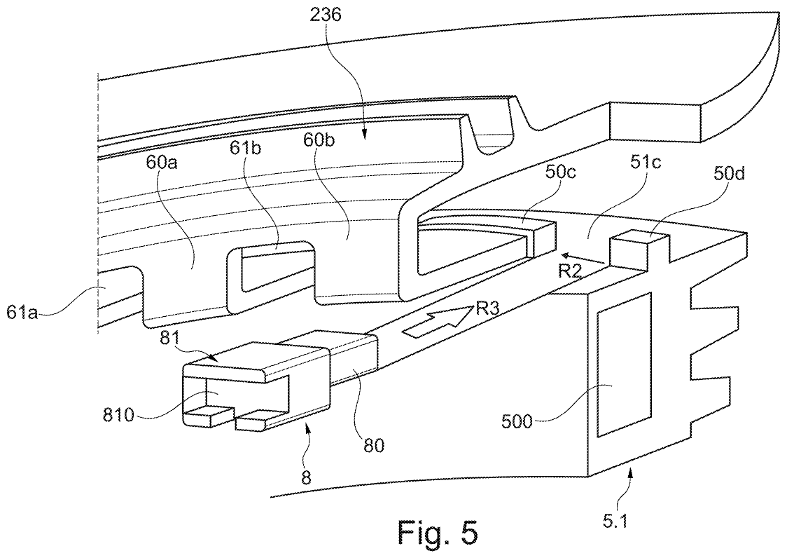

FIG. 5 shows, on an enlarged scale, a further perspective front view with the stiffening element in the barrier position and the locking element that is to be inserted thereat;

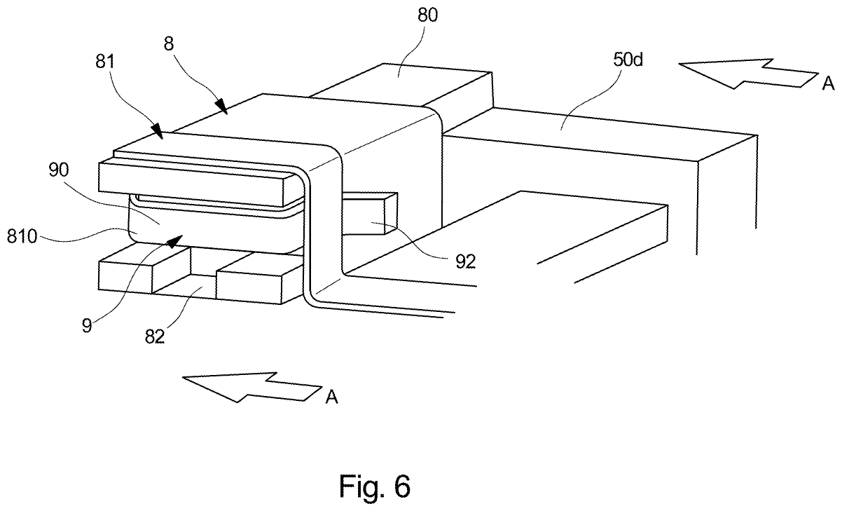

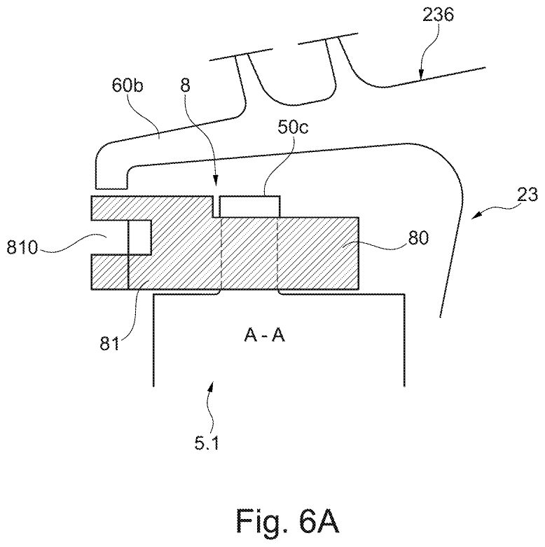

FIG. 6 shows, in sections, a detailed rendering of the stiffening element in its barrier position with inserted pin-shaped locking element and a securing bracket securing the locking element;

FIG. 6A shows a sectional view according to the section line A-A of FIG. 6;

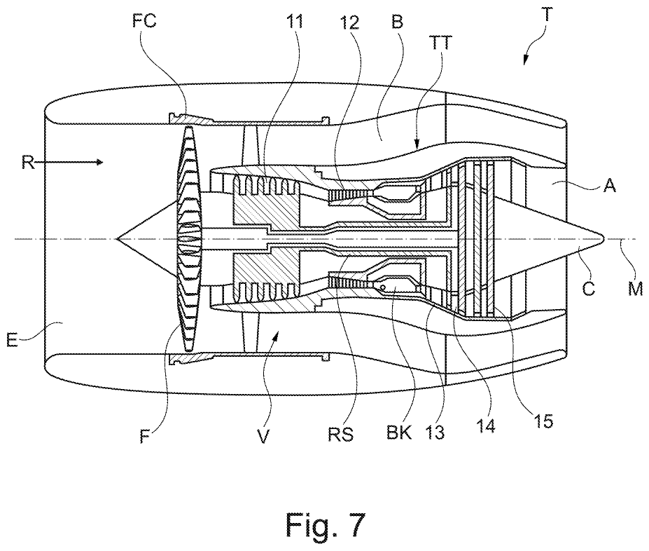

FIG. 7 shows a cross-sectional view of a turbofan engine in which an embodiment variant of a rotor blade assembly group according to the invention is used in the area of a high-pressure turbine.

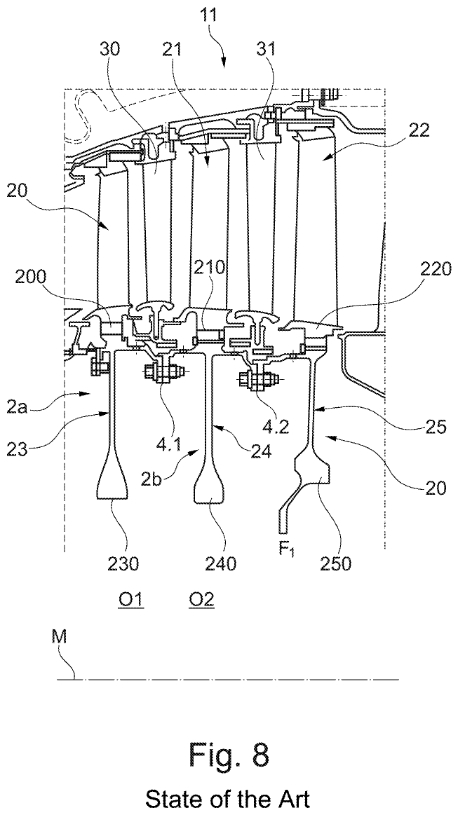

FIG. 8 shows, in sections and in sectioned rendering, a design of rotor blade rows of a turbine of a gas turbine engine as it is known from the state of the art

FIG. 7 illustrates schematically and in sectional view, a gas turbine engine T, in which the individual engine components are arranged in succession along a rotational axis or central axis M and the engine T is embodied as a turbofan engine. By means of a fan F, air is suctioned in along an entry direction at an inlet or an intake E of the engine T. This fan F, which is arranged inside a fan housing FC, is driven by means of a rotor shaft S that is set into rotation by a turbine TT of the engine T. Here, the turbine TT connects to a compressor V, which for example has a low-pressure compressor 11 and a high-pressure compressor 12, and where necessary also a medium-pressure compressor. The fan F supplies air to the compressor V, on the one hand, and, on the other, to a secondary flow channel or bypass channel B for creating a thrust. Here, the bypass channel B extends about a core engine that comprises the compressor V and the turbine TT, and also comprises a primary flow channel for the air that is supplied to the core engine by the fan F.

The air that is conveyed by means of the compressor V into the primary flow channel is transported into the combustion chamber section BK of the core engine where the driving power for driving the turbine TT is generated. For this purpose, the turbine TT has a high-pressure turbine 13, a medium-pressure turbine 14, and a low-pressure turbine 15. The turbine TT drives the rotor shaft S and thus the fan F by means of the energy that is released during combustion in order to generate the necessary thrust by means of the air that is conveyed into the bypass channel B. The air from the bypass channel B as well as the exhaust gases from the primary flow channel of the core engine are discharged by means of an outlet A at the end of the engine T. Here, the outlet A usually has a thrust nozzle with a centrally arranged outlet cone C.

It is known to use rotor blade assembly groups, which rotate about the central axis M and have respectively one rotor blade row and in which the rotor blades are provided at a ring-shaped or disc-shaped blade carrier, in the area of the (axial) compressor with its low-pressure compressor 11 and its high-pressure compressor 12, as well as in the area of the turbine TT. Here, the ring-shaped or disc-shaped blade carrier can in principle be integrally provided with blades, and thus be produced in bling or blisk design. Alternatively, the fixation of individual rotor blades is possible at the ring-shaped or disc-shaped blade carrier via the respective blade root. For this purpose, for example a blade root is axially inserted into a fastening groove of the blade carrier and axially secured at the respective blade carrier.

Based on FIG. 8, multiple rotor blade assembly groups 2a, 2b and 2c of the turbine TT, which are arranged behind each other along the central axis M, are illustrated by way of example. Here, the section shown in FIG. 5 only shows a part above the central axis M in the area of the medium-pressure turbine 14 or the low-pressure turbine 15. The individual rotor blade assembly groups 2a, 2b and 2c are connected to each other by means of flange connections 4.1 and 4.2 in a torque-proof manner. Further, each rotor blade assembly group 2a, 2b and 2c has respectively one ring-shaped or disc-shaped blade carrier 23, 24 or 25, at which individual rotor blades 20, 21 or 22 of a blade/vane row are arranged behind each other along a circle line about the central axis M, and are fixated at respective blade carriers 23, 24 or 25 via a blade root 200, 210 or 220 of a rotor blade 20, 21 or 22. Here, rotor blade rows of the rotor blade assembly groups 2a, 2b and 2c alternate with stationary guide vane rows in the axial direction along the central axis M. The guide vane rows respectively have guide vanes 30 or 31 that are also arranged circumferentially along a circle line about the central axis M.

Due to the high rotational speeds and the resulting loads, each blade carrier 23, 24 or 25 of a rotor blade assembly group 2a, 2b or 2c of the state of the art has a radially inwardly extending carrier section 230, 240 or 250. A disc-shaped carrier section 250 of the rear rotor blade assembly group 2c may for example serve for rotatably mounting the rotor blade assembly groups 2a, 2b and 2c that are interconnected in a torque-proof manner. In the carrier section 230, 240 of two frontal rotor blade assembly groups 2a and 2b—with regard to the flow direction through the engine T—a central passage opening O1 or O2 is provided primarily for the purpose of weight reduction, for example in the form of a bore. As for the necessary installation space of the rotor blade assembly groups 2a and 2b as well as their weight, it is above all important what radial extension the blade carriers 23 and 24 have to be able to withstand the loads that occur during operation.

In the different variants of a proposed solution, which are for example illustrated in FIG. 1 by way of example based on two rotor blade assembly groups 2a and 2b of the high-pressure turbine 13, a considerable reduction of the radially extending carrier sections 230 or 240 is achieved by providing respectively one stiffening structure 5a or 5b. Each stiffening structure 5a or 5b has two ring-shaped stiffening elements in the form of (MMC) stiffening rings 5.1 and 5.2 that are arranged to be located opposite each other at the face sides of the respective blade carriers 23 or 24. The stiffening rings 5.1 and 5.2 respectively engage in a form-fit manner around projections of a connecting area 231 or 241 of the respective carrier section 230 or 240 that forms a continuous profile in the circumferential direction. Here, the connecting area 231, 241 is respectively provided with a fir-tree-shaped (cross-sectional) profile.

Each stiffening ring 5.1, 5.2 of the respective stiffening structure 5a or 5b has a sheathed MMC core 500, for example a TiMMC core. By manufacturing the stiffening rings 5.1 and 5.2 in MMC design, a considerably higher stiffness of the blade carrier 23 or 24 is achieved with a comparatively light weight. Here, through the stiffening structure 5a or 5b with the stiffening rings 5.1 and 5.2 that are arranged at face sides of the blade carrier 23 or 24 that are facing away from ach other, in particular radially acting forces can be received. But at the same time a simpler mounting and a simple radial securing of the stiffening rings 5.1 and 5.2 that are to be mounted at the blade carrier 23 or 24 is provided through the circumferential profiling of the connecting area 231 or 241.

In the embodiment variant of FIG. 1, the one rotor blade assembly group 2a is connected in a torque-proof manner via a flange area 2300 of its carrier section 230 to two engine components by means of flange connections 7.1 and 7.2; upstream via a flange section 230a of the flange area 2300 to a first engine component, on the one hand, and at an axial distance thereto downstream via a second flange section 230b of the flange area 2300 to a second engine component in the form of the further rotor blade assembly group 2b which defines a downstream further rotor blade row of the high-pressure turbine 13. Here, the flange area 2300 extends radially further inside with respect to the connecting area 231 at the fir-tree-shaped cross-sectional profile of which the stiffening rings 5.1 and 5.2 the stiffening structure 5a of the rotor blade assembly group 2a are arranged at the font end.

For axially securing the stiffening rings 5.1 and 5.2 at the blade carrier 23, two barrier elements 6.1 and 6.2 are provided. Here, both barrier elements 6.1 and 6.2 are fixated at or to one of the flange sections 230a, 230b of the blade carrier 23. At that, an axially frontal barrier element 6.1 is fixated via the flange connection 7.1 to the flange section 230a. The barrier element 6.1 is formed at a flange section 206a at which the flange section 230a of the blade carrier 23 is fixated for forming the flange connection 7.1 The axially rear barrier element 6.2 is fixated via a [flange connection] 7.2 at or to the flange section 230b of the blade carrier 23. For forming this flange connection 7.2, the flange section 230b of the blade carrier 23 of the (first, left-hand) rotor blade assembly group 2a and a flange section 240a of the blade carrier 24 of the in flow direction downstream rotor blade row or the following (second, right-hand) rotor blade assembly group 2b are connected to each other in a torque-proof manner.

At that, the rear barrier element 6.2 is fixated at or to the flange section 230b via a base 62c, and extends radially outwards from the flange connection 7.2. Here, the base 62c can also be formed by a web, a circular disc segment or a circular disc. Formed at a radially outer end of the base 62c is a barrier element section 62a that extends axially in the direction of the (rear) stiffening ring 5.2. Through the connection of the two rotor blade assembly groups 2a and 2b to the flange sections 230b and 240a, the barrier element section 62a is pressed in the axial direction against the rear stiffening ring 5.2, and thus the stiffening ring 5.2 is axially secured at the rear face side of the blade carrier 23.

By contrast, the stiffening ring 5.1 provided at the opposite radial frontal face side abuts the barrier element section 62b of the barrier element 6.1 and is axially secured in this manner. At that, this frontal barrier element 6.1 is pressed against the stiffening ring 5.1 during the mounting of the rotor blade assembly group 2a to the flange 206a. Both stiffening rings 5.1 and 5.2 of the stiffening structure 5a are thus automatically axially secured through the barrier elements 6.1 and 6.2 as the rotor blade assembly group 2a is mounted in the high-pressure turbine 13 according to the intended use, without any need for axial securing of the stiffening rings 5.1 and 5.2, which would have to be mounted separately. Thanks to the axially acting barrier elements 6.1 and 6.2, also an axial play compensation is achieved, and the stiffening rings 5.1 and 5.2 are loaded against the blade carrier 23 with a sufficient axially acting pressing force.

For cooling the stiffening structure 5a and in particular the stiffening rings 5.1 and 5.2, cooling holes 232.1 and 232.2 are formed at the flange area 2300—and thus radially further inside with respect to the connecting area 231. Here, a first row of cooling holes 232.1 succeeding each other in the circumferential direction is provided for the frontal stiffening ring 5.1. Provided at an axial distance to the same is a second row of cooling holes 232.2 for the rear stiffening ring 5.2 that also succeed each other in the circumferential direction. Via the cooling holes 232.1 and 232.2, radially outwards flowing cooling air can be guided to the stiffening rings 5.1 and 5.2. The cooling holes 232.1 and 232.2 thus make it possible to influence the temperature in the area of the stiffening structure 5a in a targeted manner. In particular in the area of the high-pressure turbine 13, the use of TiMMC is possible for the stiffening structure 5a through the air cooling of the stiffening structure 5a.

Just as in the embodiment variant of FIG. 1, in the embodiment variant of FIG. 2, a package solution with a stabile—and in the case of the embodiment variant of FIG. 2 mutual—axial support of stiffening structures 5a, 5b of rotor blade assembly groups 2a, 2b is achieved.

In the embodiment variant of FIG. 2, stiffening structures 5a and 5b with respectively two stiffening rings 5.1 and 5.2 are respectively provided at two rotor blade assembly groups 2a and 2b axially succeeding one another, wherein in particular two opposite stiffening rings 5.2 and 5.1 of the two rotor blade assembly groups 2a and 2b are supported and axially secured against each other via an intermediate barrier element 6.2.

Here, the barrier element 6.2 is again provided at the flange connection 7.2 in the area of the flange sections 230a and 240a. However, in contrast to the embodiment variant of

FIG. 1, two axially protruding barrier element sections 62a and 62b extending opposite to one another project at the base 62c of the barrier element 6.2 of FIG. 2, so that the barrier element 6.2 is T-shaped in cross-sectional view.

While a first barrier element section 62a extends in the direction of the rear stiffening ring 5.2 of the first rotor blade assembly group 2a, the other, second barrier element section 62b extends axially in the direction of the frontal stiffening ring 5.1 of the second rotor blade assembly group 2b. When the two rotor blade assembly groups 2a and 2b are affixed at each other in this manner, the two opposite stiffening rings 5.2 and 5.1 and consequently the stiffening structures 5a and 5b formed with them are axially secured against each other by means of an individual common barrier element 6.2.

Incidentally, also in the embodiment variant of FIG. 2, the frontal stiffening ring 5.1 of the frontal rotor blade assembly group 2a, is axially secured against a barrier element 6.1 of the flange section 206a. The rear stiffening ring 5.2 of the rear rotor blade assembly group 2b is in turn axially secured by means of a dedicated third barrier element 6.3 which is fixated with a flange section 240b of the blade carrier 24 of the further rotor blade assembly group 2b. Via a flange connection 7.3, this (rear) flange section 240b is connected in a torque-proof manner to a flange section 206b at which the barrier element 6.3 is formed with a radially outwards extending base 62c and a barrier element section 62b that protrudes axially in the direction of the stiffening ring 5.2.

In the embodiment variant of FIG. 3, an axial securing is provided for the frontal stiffening ring 5.1 via a blade-carrier-side barrier element 236, by way of example. This barrier element 236 is formed at the blade carrier 23 of the rotor blade assembly group 2a and extends radially inwards with at least one barrier element section 60a, 60b to engage around the stiffening ring 5.1 in a form-fit manner at a radially outer edge.

As shown in the combined view of FIGS. 4, 5, 6 and 6A, the barrier element 236 can extend in a circular or circular-segment-shaped manner about the central axis M and along can comprise multiple barrier element sections 60a, 60b along a circumferential direction about the central axis M. These barrier element sections 60a, 60b engage around the stiffening ring 5.1 at multiple locations along the circumference in such a manner that, in the assembled state of the rotor blade assembly group 2a according to the intended use, multiple securing sections of the stiffening ring 5.1 in the form of respectively one radially protruding securing notch 50a to 50d are received between a barrier element section 60a, 60b and the carrier section 231.

The barrier element 236 of the blade carrier 23 shown in more detail in FIGS. 4 to 6A has respectively one gap 61a, 61b or 61c between the barrier element sections 60a and 60b that are arranged in a manner distributed along the circumference, extending radially and axially with respect to the central axis M. Into these gaps 61a to 61c, respectively one securing notch 50a to 50d of the stiffening ring 5.1 can be inserted during mounting of the stiffening structure 5a at the blade carrier 23. For this purpose, each radially outwards protruding securing notch 50a to 50d is dimensioned to be smaller than a respective gap 61a to 61c of the blade-carrier-side barrier element 236. The stiffening ring 5.1 can thus be arranged in an axial direction R1 (cf. FIG. 4) at the blade carrier 23, so that the stiffening ring 5.1 abuts at the fir-tree-shaped profile of the connecting area 231 of the blade carrier 23 in a form-fit manner at the one face side of the blade carrier 23, and with its securing notches 50a to 50d is received in the gaps 61a to 61c of the barrier element 236. The stiffening ring 5.1 is thus initially present at the blade carrier 23 in a defined mounting position.

For axial securing of the stiffening ring 5.1 at the blade carrier 23, the stiffening ring 5.1 is subsequently rotated into a barrier position along a circumferential direction R2 relative to the blade carrier 23. By rotating the stiffening ring 5.1, the individual securing notches 50a to 50d respectively move into a groove or a gap 600 that is bordered by a barrier element section 60a, 60b of the barrier element 236. By introducing a securing notch 50a to 50d into the respective gap 600, a barrier element section 60a, 60b respectively engages around it, or the stiffening ring 5.1 engages around the barrier element sections 60a, 60b of the blade-carrier-side barrier element 236 via the securing notches 50a to 50d. The stiffening ring 5.1 is thus locked at the blade carrier 23 through rotation in the circumferential direction R2 in the kind of a bayonet joint.

To subsequently secure the stiffening ring 5.1 against axial twisting relative to the blade carrier 23 and thus to lock a barrier position taken by the stiffening ring 5.1, in which the stiffening ring 5.1 is connected to the barrier element 236 in a form-fit manner, at least one locking element in the form of a locking pin 8 is provided. This locking pin 8 is inserted in the axial direction R3 into a gap 61a, 61b or 61c between two barrier element sections 60a, 60b. Here, a shaft or spigot section 80 of the locking pin 8 meshes with multiple recesses 51a, 51b, 51c or 51d of the stiffening ring 5.1 that are respectively formed between two radially protruding securing notches 50a/50b, 50b/50c or 50c/50d. At the same time, the locking pin 8 meshes in a form-fit manner with a head 81, which is wider as compared to the shaft or spigot section 80, with the gap 61b of the barrier element 236 formed between two barrier element sections 60a, 60b.

If the locking pin 8 is inserted according to the intended use at the stiffening ring 5.1 and the barrier element 236 of the blade carrier 23, the shaft or spigot section 80 of the locking pin 8 e.g. meshes in a recess 51b of the stiffening ring 5.1 that is present in the gap 61b. The head 81 of the locking pins 8 is almost completely or completely received inside the gap 61b, and with a bottom side abuts a face side 510 of two adjacent securing notches 50b and 50c.

If the locking pin 8 is inserted, the stiffening ring 5.1 is blocked against twisting relative to the blade carrier 23 and thus relative to the blade-carrier-side barrier element 236. Only by removing the locking pin 8—for example for maintenance or repair work—twisting of the stiffening ring 5.1 and thus its return into a mounting position, in which the stiffening ring 5.1 can be removed from the blade carrier 23, can be allowed.

To secure the locking pin 8 itself at the blade carrier 23 and in particular at the barrier element 236, a separately mountable securing element in the form of a securing bracket 9 is provided. At that, the securing bracket 9 with its U-shaped cross section is inserted into a gap-like receptacle 810 at the head 81 of the locking pin 8, if the locking pin 8 has been inserted at the barrier element 236 and the stiffening ring 5.1 in its barrier position according to the intended use. At that, the securing bracket 9 is inserted with a base 90 into the receptacle 810 of the locking pin 8 along an axial (mounting) direction R4. At that, spring-elastic bracket ends 91 and 92 protruding laterally from the base 90, are inserted behind adjacent barrier element sections 60a, 60b, so that the bracket ends 91 and 92 respectively engage behind one barrier section 60a or 60b. In this manner, the securing bracket 9 is arrested at the barrier element 236 and axially secures the locking pin 8 against being removed from the blade carrier 23. To illustrate this axial securing, FIG. 4 also shows a securing bracket 9 without a locking pin 8, for example.

Via an access opening 82 at the head 81 of the locking pin 8, the base 90 of the inserted securing bracket 9 can be accessed to be able to remove it from the locking pin 8, if needed.

For locking the stiffening ring 5.1 in the barrier position, a locking pin 8 with the securing bracket 9 inserted thereat may be sufficient. However, in principle multiple locking pins 8 distributed across the circumference can of course also be provided with a securing bracket 9 and inserted into respectively one of multiple gaps 61a to 61c provided at the ring-shaped circumferential barrier element 236.

In principle, for avoiding abrasion and wear, a coating can be provided at the surfaces of two components of a rotor blade assembly group 2a, 2b that are in contact with each other. Thus, for example a coating can in particular be provided at the connecting area 231, 241, e.g. at the fir-tree-shaped profile, and/or at a barrier element section 60a, 60b, 62a or 62b.

### PARTS LIST

11 low-pressure compressor
12 high-pressure compressor
13 high-pressure turbine
14 medium-pressure turbine
15 low-pressure turbine
20, 21, 22 rotor blade
200, 210, 220 blade root
206a, 206b flange section
23, 24, 25 blade carrier
230, 240, 250 carrier section
230a, 230b flange section
231, 241 connecting area
232.1, 232.2 cooling hole
236 barrier ring (barrier element)
2300 flange area
240a, 240b flange section
2a, 2b, 2c rotor blade assembly group
30, 31 guide vane
4.1, 4.2 flange connection
5.1, 5.2 stiffening ring (stiffening element)
500 MMC core
50a, 50b, 50c, 50d securing notch (securing section)
510 end face
51a, 51b, 51c, 51d recess
5a, 5b stiffening structure
6.1, 6.2, 6.3 barrier element
600 gap
60a, 60b barrier element section
61a, 61b, 61c gap
62a, 62b barrier element section
62c base
7.1, 7.2, 7.3 flange connection
8 locking pin (locking element)
80 shaft/spigot section
81 head
810 receptacle
82 access opening
9 securing bracket (securing element)
90 base
91, 92 bracket end
A outlet
B bypass channel
BK combustion chamber section
C outlet cone
E inlet/intake
F fan
FC fan housing
M central axis/rotational axis
O1, O2 passage opening
R entry direction
R1, R2, R3, R4 direction
S rotor shaft
T turbofan engine (gas turbine engine)
TT turbine
V compressor

1. A rotor blade assembly group for an engine, with at least one blade carrier which has at least one rotor blade that is provided with multiple rotor blades along a circle line about a central axis of the rotor blade assembly group, wherein
the blade carrier has a carrier section that extends radially inwards in the direction of the central axis with respect to the at least one rotor blade,
the carrier section comprises a connecting area at which a stiffening structure with at least one stiffening element is fixedly arranged, and
the at least one stiffening element is arranged at a face side of the blade carrier,
wherein
the at least one stiffening element is axially secured at the face side of the blade carrier via at least one barrier element that is
(a) fixated radially further inside at or to a flange section of the blade carrier, or
(b) is formed by the blade carrier and with at least one barrier element section engaging around the stiffening element.

2. The rotor blade assembly group according to claim 1, wherein the barrier element that is affixed at or to the flange section of the blade carrier extends radially outwards with a base.

3. The rotor blade assembly group according to claim 2, wherein an axially extending barrier element section for axial securing of the at least one stiffening element is provided at the base.

4. The rotor blade assembly group according claim 1, wherein the blade carrier is connected to one further blade carrier via the flange section.

5. The rotor blade assembly group according to claim 4, wherein at one carrier section of the further blade carrier a further stiffening structure with at least one further stiffening element is fixedly attached, the two stiffening elements of the interconnected blade carriers are located opposite each other, and the barrier element is arranged between the two stiffening elements.

6. The rotor blade assembly group according to claim 5, wherein the barrier element has two barrier element sections of which a first barrier element section extends axially in the direction of the one stiffening element and a second barrier element section extends axially opposite to the same in the direction of the other stiffening element.

7. The rotor blade assembly group according to claim 5, wherein the stiffening structures of the two interconnected blade carriers are axially secured against each other via the barrier elements.

8. The rotor blade assembly group according to claim 1, wherein the barrier element section of the barrier element formed by the blade carrier with which the barrier element engages around the stiffening element extends radially inwards.

9. The rotor blade assembly group according to claim 1, wherein the barrier element formed by the blade carrier comprises at least two barrier element sections that succeed each other along a circumferential direction about the central axis, and between which a radially and axially extending gap is present.

10. The rotor blade assembly group according to claim 9, wherein at the stiffening element at least one radially protruding securing section is provided, that can be inserted into the gap between the two barrier element sections in the axial direction for mounting the rotor blade assembly group.

11. The rotor blade assembly group according to claim 10, wherein, in the assembled state of the rotor blade assembly group according to the intended use, one of the at least two barrier element sections that succeed one another along a circumferential direction about the central axis engage around at least one radially protruding securing section.

12. The rotor blade assembly group according to claim 9, wherein multiple gaps are present at the barrier element, wherein one gap is respectively provided between two barrier element sections that succeed one another along the circumferential direction, and/or multiple securing sections arranged at a distance to each other are provided at the stiffening element in the circumferential direction.

13. The rotor blade assembly group according to claim 1, wherein at least one separately mountable locking element for securing the stiffening element is provided against twisting relative to the blade carrier.

14. The rotor blade assembly group according to claim 13, wherein the at least one locking element is formed in a pin-shaped manner and/or is axially mountable at the blade carrier.

15. The rotor blade assembly group according to claim 14, wherein the at least one locking element can be affixed via a securing element at the blade carrier.

16. The rotor blade assembly group according to claim 9, wherein the at least one locking element is inserted into the gap between the two barrier element sections.

17. The rotor blade assembly group according to claim 12, wherein a recess is provided between two of the securing sections provided at the stiffening element, which in the assembled state of the rotor blade assembly group according to the intended use is located at least partially in the gap between the two barrier element sections, so that the locking element inserted in the gap also meshes in the recess of the stiffening element.

18. The rotor blade assembly group according to claim 17, wherein the recess of the stiffening element has a smaller extension in the circumferential direction than the gap of the barrier element.

19. The rotor blade assembly group according to claim 1, wherein at least one cooling hole for the cooling air that is to be guided to the stiffening structure is provided at the carrier section.

20. The rotor blade assembly group according to claim 1, wherein at least one stiffening element is formed in a ring-shaped manner.

21. The rotor blade assembly group according to claim 1, wherein at least one stiffening element has a metal matrix composite.

22. The rotor blade assembly group according to claim 21, wherein at least one stiffening element has an externally sheathed core of a metal matrix composite.

23. A gas turbine engine with at least one rotor blade assembly group according to claim 1.

24. A method for mounting a stiffening element at a rotor blade assembly group provided for an engine, wherein the rotor blade assembly group comprises at least one blade carrier that has at least one rotor blade that is provided with multiple rotor blades along a circle line about a central axis of the rotor blade assembly group, wherein the blade carrier has a carrier section which extends radially inwards in the direction of the central axis with respect to the at least one rotor blade, and at which a stiffening structure with the stiffening element is mounted at a face side of the blade carrier and the stiffening element is fixedly attached,
wherein the stiffening element is axially secured at the face side of the blade carrier via at least one barrier element that
(a) is fixated radially further inside at or to a flange section of the blade carrier, or
(b) is formed in front of the blade carrier and engages around the stiffening element with at least one barrier element section.

25. The method according to claim 24, wherein the blade carrier is connected in a torque-proof manner to a further engine component via the flange section, with the barrier element being axially pressed against the stiffening element.

26. The method according to claim 24, wherein the stiffening element is initially arranged in a mounting position at the carrier section, and is subsequently rotated into a barrier position along a circumferential direction about the central axis relative to the carrier section, in which the at least one securing section radially protruding at the stiffening element is received inside a gap bordered by the at least one barrier element section, so that the barrier element section engages around the stiffening element at the securing section.

27. The method according to claim 26, wherein, if the stiffening element is in the barrier position, a locking element is mounted at the blade carrier, via which the stiffening element is secured against a twisting relative to the carrier section.
